(19) United States
(12) Patent Application Publication
(10) Pub. No.: US 2009/0217170 A1
(43) Pub. Date: Aug. 27, 2009

(54) SYSTEM AND METHOD FOR SHARING DISPLAY INFORMATION

(75) Inventors: Rong-Wen Chang, Fremont, CA (US); John K. Lee, Fremont, CA (US); Ron Lin, Fremont, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AUDIVIDI INC., George Town (KY)

(21) Appl. No.: 12/392,292

(22) Filed: Feb. 25, 2009

Related U.S. Application Data
(60) Provisional application No. 61/031,746, filed on Feb. 27, 2008.

(51) Int. Cl. G06F 3/048; G06F 15/16

(52) U.S. Cl. 715/733; 715/781; 709/204

(57) ABSTRACT

A system for sharing display information comprising a network apparatus for connecting to a receiver of display information, and a memory for storing at least one program, a first graphics driver, a second graphics driver, and a network sharing program. A processor configured to execute the program, the first graphics driver, and the second graphics driver stored in the memory. The program is executed for generating display information to the first graphics driver. The first graphics driver is executed for forwarding display information to the second graphics driver and the network sharing program. The network sharing program is executed for processing display information and for sending the processed display information to the receiver through the network apparatus. The second graphics driver is executed for translating display information. The system also includes a graphics apparatus for generating display information of a whole desktop according to display information sent from the second graphics driver.

### CROSS REFERENCE TO RELATED APPLICATIONS

This application claims the benefit of U.S. Provisional Application No. 61/031,746, filed Feb. 27, 2008.

### BACKGROUND OF THE INVENTION

1. Field of the Invention

The invention is related generally to sharing information in an interconnected network environment, more specifically, is related to sharing display information of a specific computer program efficiently.

2. Description of the Related Art

Sharing information such as computer desktop in an interconnected network environment is more and more common in modern days. Various applications like remote teaching and teleconference systems are required for students and participants to see a shared display screen of the lecturer or speaker.

A common technique used in implementing the sharing of display screen is to capture the host computer screen's bit map, which may represent colors and/or transparency information of each pixel. Once the bit map of screen is captured, it is then replicated to all the remote systems for display through the interconnection network.

Please refer to FIG. 1 representing a block diagram of a conventional host system 100 for sharing display information. The system comprises a plurality of application programs 110 which sends display information to its corresponding window 130 via a graphics driver 124 when it is activated in an operating system 120. A graphics subsystem 122 of the operating system 120, for example, Microsoft Windows series operating systems, is responsible to manage the screen display 140 of multiple windows 130 according to the overlap order or precedent order. A window underneath other windows is partially blocked from being viewed. Hence, the region underneath other windows 130 would not be rendered on the screen display 140. In the consequence, a bit map screen capture 142 would miss the underneath region of a window 130.

In modern multitasking operation systems, users usually have more than one program 110 running. In many circumstances, the corresponding window 130 of the shared program 110 would be covered or blocked by other windows 130 during the sharing session. Once it happened, the bit map of the blocked region is not available from the screen capture 142. Therefore all other remote systems 144 cannot display correct information of the blocked region, which have to be grayed out or blacked out to indicate that the region is not available for viewing.

In conclusion, there exists a need to have system and method for correctly sharing display information of a window which is blocked or covered by other windows.

### BRIEF SUMMARY OF THE INVENTION

In order to meet the need, a system and a method in accordance with embodiments of the present invention are provided.

The disclosed system for sharing display information comprises a network apparatus for connecting to a receiver of display information, and a memory for storing at least one program, a first graphics driver, a second graphics driver, and a network sharing program. Furthermore, a processor is configured to execute the program, the first graphics driver, and the second graphics driver stored in the memory. The program is executed for generating display information to the first graphics driver. The first graphics driver is executed for forwarding display information to the second graphics driver and the network sharing program. The network sharing program is executed for processing display information and for sending the processed display information to the receiver through the network apparatus. The second graphics driver is executed for translating display information. The system also includes a graphics apparatus for generating display information of a whole desktop according to display information sent from the second graphics driver.

In another aspect, the disclosed method for sharing display information is implemented in a system. The system comprises a network apparatus for connecting to a receiver of display information, and a memory for storing at least one program, a first graphics driver, a second graphics driver, and a network sharing program. A processor of the system is configured to execute the program, the first graphics driver, and the second graphics driver stored in the memory. An apparatus generates display information of a whole desktop. The method comprises executing the program for generating display information to the first graphics driver, executing the first graphics driver forwarding display information to the second graphics driver and the network sharing program, executing the network sharing program for processing display information and for sending the processed display information to the receiver through the network apparatus, and executing the second graphics driver for translating display information to the graphics apparatus.

### BRIEF DESCRIPTION OF THE DRAWINGS

The invention can be more fully understood by reading the subsequent detailed description and examples with references made to the accompanying drawings, wherein:

The foregoing and a better understanding of the present invention will become apparent from the following detailed description of example embodiments and claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

FIG. 1 illustrates a block diagram of a conventional host system for sharing display information.

FIG. 2 shows an exemplary system in accordance with an embodiment of the present invention.

FIG. 3 represents a block diagram of another embodiment according to present invention.

FIG. 4 depicts an exemplary method embodiment according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Before beginning a detailed description of the preferred embodiments of the invention, the following statements are in order. The preferred embodiments of the invention are described with reference to an exemplary system for sharing display information. However, the invention is not limited to the preferred embodiments in its implementation. The invention, or any aspect of the invention, may be practiced in any suitable teleconference system, including a multi-media phone system, multi-media server, multi-media player, or multi-source and broadcast center. Portions of the preferred embodiments are shown in block diagram form and described in this application without excessive detail in order to avoid obscuring the invention, and also in view of the fact that specifics with respect to implementation of such a system are known to those of ordinary skill in the art and may be dependent upon the circumstances. In other words, such specifics are variable but should be well within the purview of one skilled in the art. Conversely, where specific details are set forth in order to describe example embodiments of the invention, it should be apparent to one skilled in the art that the invention can be practiced without, or with variation of, these specific details. In particular, where particular display screens are mere examples and may be modified or replaced with different displays without departing from the invention.

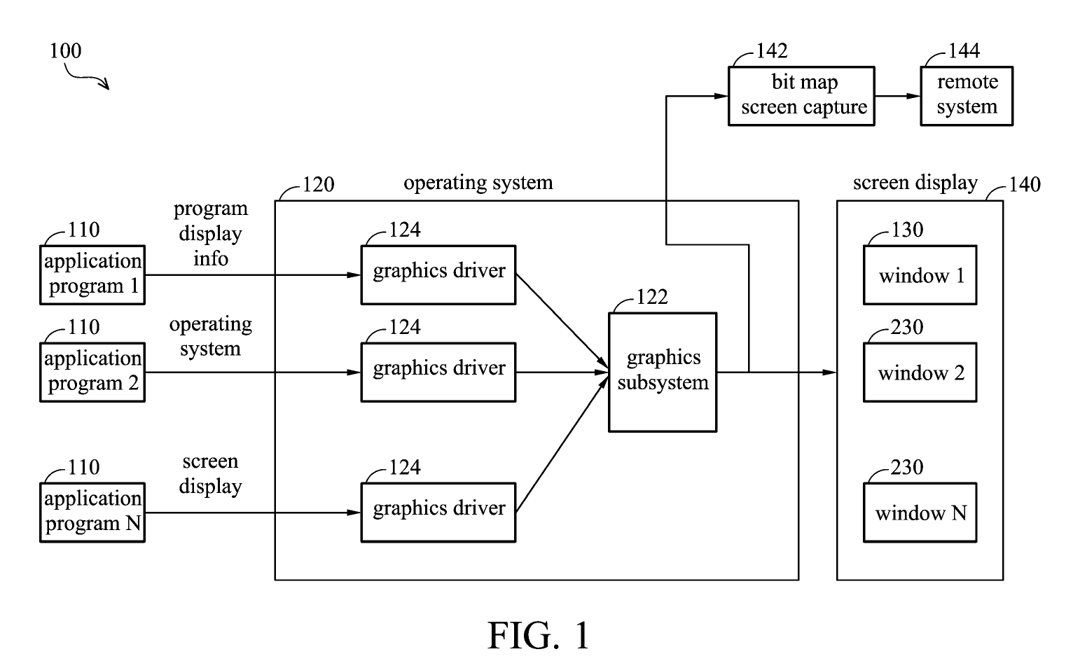

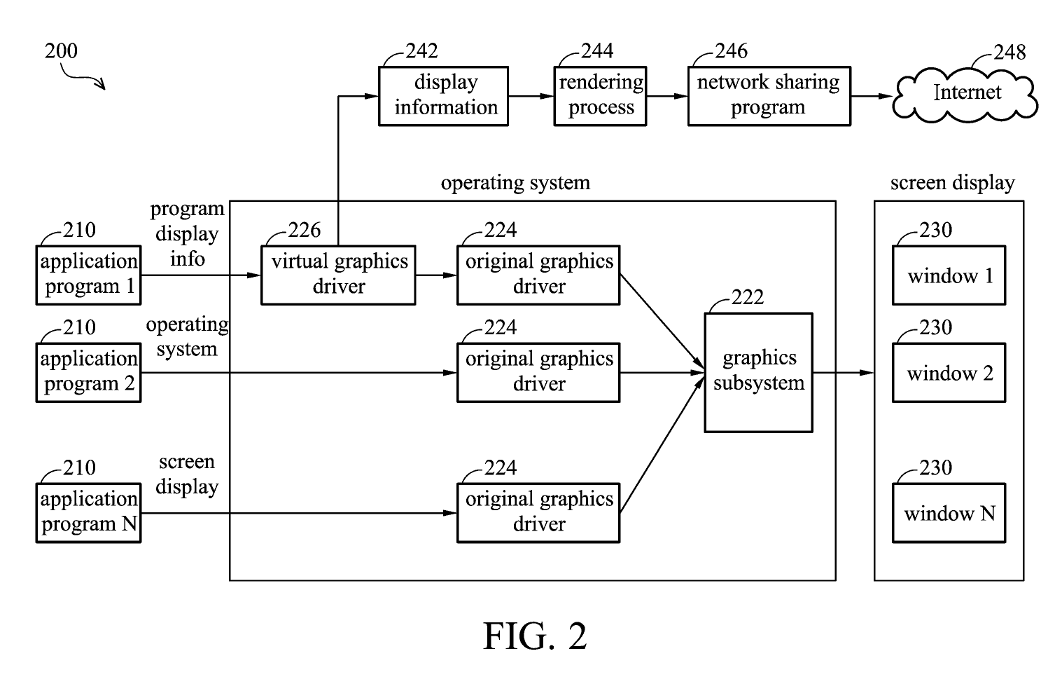

Please refer to FIG. 2, which shows an exemplary system 200 in accordance with an embodiment of the present invention. Comparing to the conventional system 100 shown in the FIG. 1, the system 200 comprises a virtual graphics driver 226 which is used to capture the display information of an application program 210 is shared to other remote systems. In the present invention, the system 200 may be a teleconference system in which the shared display information could be used in an online meeting or remote control session. The virtual graphics driver 226 is installed between the application program 210 and the original graphics driver 224. It passes all the display information from the application program 210 directly to the original graphics driver 224 for local rendering. So, overall operations of the graphics subsystem 222 are not altered comparing to the conventional subsystem 122.

Meanwhile, the virtual graphics driver 226 sends all intercepted display information 242 to another rendering process 244 to create a duplicate copy of the display of the shared program 210. The captured display information 242 is continuously updated even the corresponding window 230 is blocked or minimized, consequently, the rendering process 244 renders a bitmap from the intercepted display information 242 regardless of the order and position of the shared program 210 with respect to other windows 230. Through a network sharing program 246, the bitmap rendered from the rendering process 244 can be replayed on all other remote systems (not shown) through internet 248, or sent to a media server (not shown) for further processing, replication, and distribution. The network sharing program 246 is operative to encode, encrypt or compress the bitmap output from the rendering process 244 before sending them to a remote system (not shown) via the internet 248.

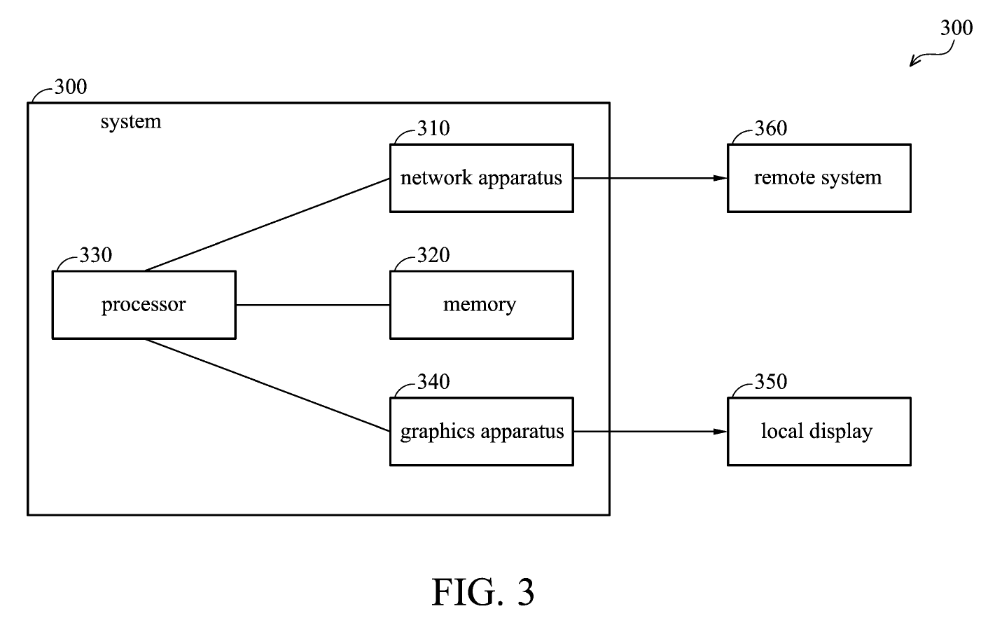

Please refer to FIG. 3, which represents a block diagram of another embodiment according to the invention. The exemplary system 300 comprises a network apparatus 310 for connecting to a receiver 360 of shared display information, and a memory 320 for storing at least one program, a first graphics driver, a second graphics driver, and a network sharing program. A processor 330 is used to execute the program, the first graphics driver, and the second graphics driver stored in the memory 320. Moreover, a graphics apparatus 340 is used to generate display information of a whole desktop shown in a local display 350.

In one embodiment, the graphics apparatus 340 may comprise a graphics processing unit and dedicated memory for the local display 350. In addition to render the desktop of the local display 350, the graphics apparatus 340 may also have acceleration capability in 2-dimension and/or 3-dimension image process. According to an embodiment, the second graphics driver is designed to translate display information to adapt to the underlying operations of this corresponding graphics apparatus 340.

In a normal practice, the program may be executed by the processor 330 to generate display information, which may include bit map of a corresponding window, to the second graphics driver for the corresponding graphics apparatus 340. Based on the present invention, the display information to be shared generated from the program is sent to the first graphics driver. So it can be forwarded to the second graphics driver and to the network sharing program. In other words, the display information received from the program and sent to the second graphics driver by the first graphics driver is identical. Once the second graphics driver received the display information, it would be processed as usual before sending to the graphics apparatus 340. Hence, user of this system 300 can view the corresponding window on the local display 350 as usual. The window area is equaled or smaller than the whole desktop shown in the local display 350.

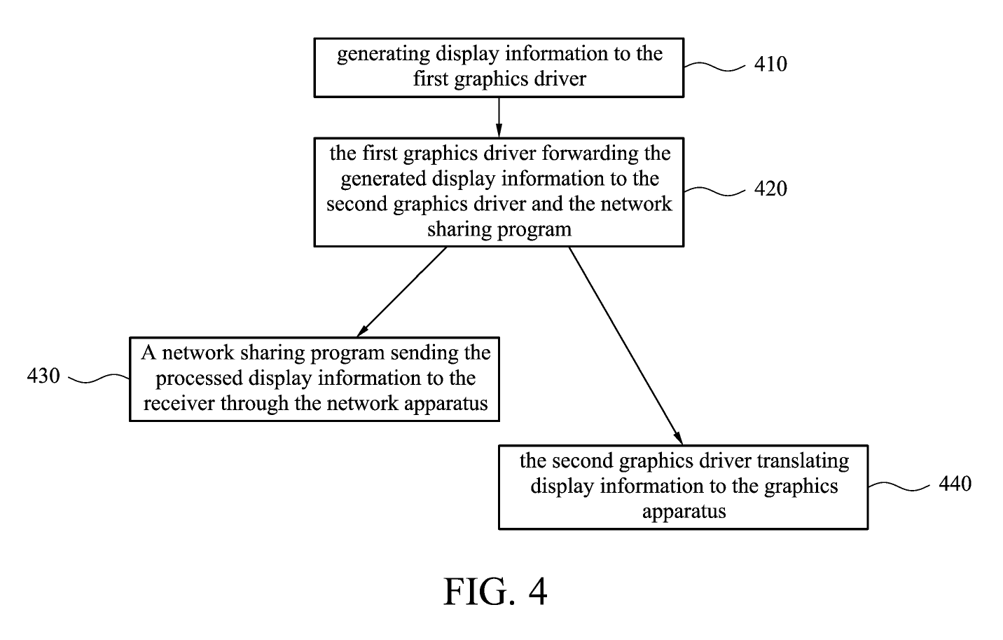

In one embodiment, the display information received by the network sharing program would be processed prior to send to the network apparatus. The process performed by the network sharing program may include various operations such as encoding, encryption, and compression of the bitmap output from the rendering process 244 to optimize the data sharing over networks. Please refer to FIG. 4, which depicts an exemplary method embodiment according to an embodiment of the present invention. With respect to the system 300, the embodied method could be realized. In a step 410, the program is executed for generating display information to the first graphics driver. Later, in a step 420, the generated display information is forwarded by the first graphics driver to the second graphics driver and the network sharing program. The steps 430 and 440 could be executed with no time dependency relationship. The network sharing program is executed for processing display information and for sending the processed display information to the receiver through the network apparatus in the step 430. The second graphics driver is executed by the processor for translating display information to the graphics apparatus in the step 440.

In conclusion, in implementations of the present invention, the window of a shared application can be correctly displayed on other remote systems even when the window is blocked by other windows in the local host system. While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for sharing display information, comprising:
a network apparatus for connecting to a receiver of display information;
a memory for storing at least one program, a first graphics driver, a second graphics driver, and a network sharing program;
a processor for executing the program, the first graphics driver, and the second graphics driver, wherein the program is executed for generating display information to the first graphics driver, wherein the first graphics driver is executed for forwarding display information to the second graphics driver and the network sharing program, wherein the network sharing program is executed for processing display information and for sending the processed display information to the receiver through the network apparatus, wherein the second graphics driver is executed for translating display information; and
a graphics apparatus for generating display information of a whole desktop according to display information sent from the second graphics driver.

2. The system of claim 1, wherein the display information generated by the program represents a window area of the whole desktop, wherein the window area is equaled or smaller than the whole desktop.

3. The system of claim 2, wherein the display information further comprises a bit map of the window area.

4. The system of claim 1, wherein the network sharing program is further executed for rendering and compressing display information prior to sending the processed display information to the receiver.

5. The system of claim 1, wherein the display information received from the program and sent to the second graphics driver by the first graphics driver is identical.

6. A method for sharing display information in a system, wherein the system comprising a network apparatus for connecting to a receiver of display information; a memory for storing at least one program, a first graphics driver, a second graphics driver, and a network sharing program; a processor; and a graphics apparatus for generating display information of a whole desktop, the method comprising:
executing, by the processor, the program for generating display information to the first graphics driver;
executing, by the processor, the first graphics driver forwarding display information to the second graphics driver and the network sharing program;
executing, by the processor, the network sharing program for processing display information and for sending the processed display information to the receiver through the network apparatus; and
executing, by the processor, the second graphics driver for translating display information to the graphics apparatus.

7. The method of claim 6, wherein the display information generated by the program represents a window area of the whole desktop, wherein the window area is equaled or smaller than the whole desktop.

8. The method of claim 7, wherein the display information further comprises a bit map of the window area.

9. The method of claim 6, wherein the network sharing program is further executed for rendering and compressing display information prior to sending the processed display information to the receiver.

10. The method of claim 6, wherein the display information received from the program and sent to the second graphics driver by the first graphics driver is identical.
